(19) United States
(12) Patent Application Publication
(10) Pub. No.: US 2024/0037518 A1
(43) Pub. Date: Feb. 1, 2024

(54) ATOMICALLY PROCESSING OBLIGATION PAYMENTS FOR TRANSACTIONS IN REAL TIME

(71) Applicant: RTC DIGITAL PTY LTD, Sydney, New South Wales (AU)

(72) Inventors: Karl KAZAL, Sydney, New South Wales (AU); Pawel KAPLANSKI, Sydney, New South Wales (AU); Charif KAZAL, Sydney, New South Wales (AU)

(21) Appl. No.: 18/039,753

(22) PCT Filed: Dec. 7, 2021
(86) PCT No.: PCT/AU2021/051458

§ 371 Date: Jun. 1, 2023

(30) Foreign Application Priority Data
Dec. 7, 2020 (AU) 2020904521

(51) Int. Cl. G06Q 20/08; G06Q 20/10; G06Q 30/04; G06Q 40/02

(52) U.S. Cl. CPC G06Q 20/0855; G06Q 20/108; G06Q 30/04; G06Q 40/02

(57) ABSTRACT

The present disclosure provides systems and methods for atomically processing transactions including obligation payments. In one aspect, the automated system automatically calculates and processes payments for transactions between both the primary parties and with the third parties. The third party owed an obligation may have visibility into the calculations and payment processes. The system is designed to maintain atomicity of the financial transactions—including the payments owed to the third party arising out of the transaction. During the atomic processing of the transaction, obligation payments to the third party may be processed using an obligations account that tracks a balance of obligations that a particular party to a transaction owes to the third party, insuring that the third party receives the appropriate payments.

### CROSS-REFERENCE TO RELATED APPLICATIONS AND PRIORITY CLAIM

This application claims the benefit under 35 U.S.C. § 371 to International Application Number PCT/AU2021/051458 filed on Dec. 7, 2021 which claims the priority of Australian Patent Application No. 2020904521, filed on Dec. 7, 2020.—The entire disclosures of said applications are incorporated by reference herein for all purposes.

### BACKGROUND

Transactions, including online or electronically-processed transactions, can trigger financial obligations to a third party not taking part in the transaction. For example, the third party may be owed a percentage of all or certain transactions between one party and another party. To make these payments, the party responsible for the financial obligation may be responsible for reserving a portion of the proceeds for later payment to the third party.

### SUMMARY

The present disclosure presents new and innovative systems and methods for atomically processing transactions including obligation payments. In a first aspect, a system is provided that includes a first computing device, a second computing device, and a third computing device. The first computing device may be configured to receive transaction information from a customer for a two-party transaction that would result in an obligation payment to a third party and transmit a transaction request including at least a subset of the transaction information to the second computing device. The second computing device may be configured to atomically complete the two-party transaction and, as part of completing the two-party transaction, to identify, based on the transaction request, a first party responsible for paying the obligation payment. Responsive to identifying the first party responsible for paying the obligation payment, the second computing device may be configured to update a balance of an obligations account associated with the first party to incorporate the obligation payment and adjust, via the third computing device, a hold on a financial account associated with the first party based on the balance of the obligations account.

In a second aspect according to the first aspect, while atomically completing the two-party transaction, the second computing device is configured to process a payment from a second party of the two-party transaction to the first party.

In a third aspect according to the first or second aspects, while atomically completing the two-party transaction, the second computing device is configured to lock a transaction record associated with the two-party transaction until at least the hold on the financial account is successfully adjusted.

In a fourth aspect according to any of the first through third aspects, the first computing device receives the transaction information from a payment API accessed by a payer of the transaction. The payer may be presented, before the balance of the obligations account is updated, with an invoice that includes an obligation payment amount for the obligation payment.

In a fifth aspect according to any of the first through fourth aspect, increasing the balance of the obligations account indicates that the first party owes a larger obligation to the third party and decreasing the balance of the obligations account indicates that the first party owes a smaller obligation to the third party.

In a sixth aspect according to any of the first through fifth aspects, the second computing device is further configured, at the end of an obligation collections period, to transfer, via the third computing device, funds equivalent to the hold on the financial account from the financial account to an obligation collections account, remove, via the third computing device, the hold, and reset out the balance of the obligations account associated with the first party.

In a seventh aspect according to any of the first through sixth aspects, the transaction information includes information selected from the group consisting of: payer information, seller information, an obligation payment amount, and transaction verification information.

In an eighth aspect according to the seventh aspect, the second computing device is further configured to store the transaction information on a distributed ledger.

In a ninth aspect, a method is provided that includes receiving a transaction request for a two-party transaction that would result in an obligation payment to a third party and atomically completing the two-party transaction. Atomically completing the two-party transaction may include identifying, based on the transaction request, a first party responsible for paying the obligation payment. Responsive to identifying the first party responsible for paying the obligation payment, the method may include updating a balance of an obligations account associated with the first party to incorporate the obligation payment. The method may further include adjusting a hold on a financial account associated with the first party based on the balance of the obligations account.

In a tenth aspect according to the ninth aspect, atomically completing the two-party transaction further comprises processing a payment from a second party of the two-party transaction to the first party.

In an eleventh aspect according to any of the ninth and tenth aspects, atomically completing the two-party transaction further comprises locking a transaction record associated with the two-party transaction until at least the hold on the financial account is successfully adjusted.

In a twelfth aspect according to any of the ninth through eleventh aspects, the transaction is received from an application programming interface (API) accessed by a payer of the transaction. The payer may be presented, before the balance of the obligations account is updated, with an invoice that includes an obligation payment amount for the obligation payment.

In a thirteenth aspect according to any of the ninth through twelfth aspects, increasing the balance of the obligations account indicates that the first party owes a larger obligation to the third party and decreasing the balance of the obligations account indicates that the first party owes a smaller obligation to the third party.

In a fourteenth aspect according to any of the ninth through thirteenth aspects, the method further includes calculating an obligation payment amount for the obligation based on at least one pre-defined rule and a total purchase amount of the two-party transaction.

In a fifteenth aspect according to any of the ninth through fourteenth aspects, the method further includes, at the end of an obligation collections period, transferring funds equivalent to the hold on the financial account from the financial account to an obligation collections account, removing the hold, and resetting out the balance of the obligations account associated with the first party.

In a sixteenth aspect according to any of the ninth through fifteenth aspects, the transaction includes transaction information selected from the group consisting of: payer information, seller information, an obligation payment amount, and transaction verification information.

In a seventeenth aspect according to the sixteenth aspect, the method further includes storing the transaction information on a distributed ledger.

In an eighteenth aspect according to any of the sixteenth and seventeenth aspects, the first party, the obligations account, and the financial account are identified based on at least one of the seller information and/or the buyer information.

In a nineteenth aspect according to any of the ninth through eighteenth aspects, the obligation includes at least one of a royalty payment, an income garnishment, a contract payment, and a tax payment.

In a twentieth aspect, a non-transitory, computer-readable medium is provided storing instructions which, when executed by a processor, cause the processor to receive a transaction request for a two-party transaction that would result in an obligation payment to a third party and atomically complete the two-party transaction. As part of atomically completing the two-party transaction, the instructions may cause the processor to identify, based on the transaction request, a first party responsible for paying the obligation payment. Responsive to identifying the first party responsible for paying the obligation payment, the instructions may cause the processor to update a balance of an obligations account associated with the first party to incorporate the obligation payment. The instructions may further cause the processor to adjust a hold on a financial account associated with the first party based on the balance of the obligations account.

In a particular embodiment, there is provided a system comprising: a first computing device, a second computing device, and a third computing device, wherein the first computing device is configured to: receive first transaction information from a customer for a first two-party transaction; and transmit a first transaction request including at least a subset of the transaction information to the second computing device; wherein the second computing device is configured to atomically complete the first two-party transaction and, as part of completing the first two-party transaction: determine a first obligation payment to a third party associated with the first two-party transaction; identify, using first data from the first transaction request to query a first database, a first party responsible for paying the first obligation payment; responsive to identifying the first party responsible for paying the obligation payment, increase a balance of an obligations account associated with the first party to incorporate the first obligation payment; and increase, via the third computing device, a hold on a financial account associated with the first party based on the balance of the obligations account; wherein the second computing device is further configured to receive a second transaction request related to a second two-party transaction; and atomically complete the second two-party transaction and, as part of completing the second two-party transaction: determine a second obligation payment to the third party associated with the second two-party transaction; identify, using second data from the second transaction request to query the first database, a second party responsible for paying the second obligation payment; decrease the balance of the obligations account associated with the first party based on the second obligation payment; and decrease the hold on the financial account associated with the first party based on the balance of the obligations account.

In a particular embodiment, there is provided a method comprising: receiving a first transaction request for a first two-party transaction that would result in a first obligation payment to a third party; atomically completing the first two-party transaction; and as part of atomically completing the first two-party transaction: identifying, using first data from the first transaction request to query a first database, a first party responsible for paying the first obligation payment; responsive to identifying the first party responsible for paying the first obligation payment, increasing a balance of an obligations account associated with the first party to incorporate the first obligation payment; and increasing a hold on a financial account associated with the first party based on the balance of the obligations account; and receiving a second transaction request related to a second two-party transaction; atomically completing the second two-party transaction; and as part of atomically completing the second two-party transaction: determining a second obligation payment to the third party associated with the second two-party transaction; identifying, using second data from the second transaction request to query the first database, a second party responsible for paying the second obligation payment; decreasing the balance of the obligations account associated with the first party based on the second obligation payment; and decreasing the hold on the financial account associated with the first party based on the balance of the obligations account.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the disclosed subject matter.

### BRIEF DESCRIPTION OF THE FIGURES

FIGS. 1A-1B illustrates a system according to an exemplary embodiment of the present disclosure.

FIG. 2 illustrates a transaction request and transaction confirmation information according to an exemplary embodiment of the present disclosure.

FIG. 3 illustrates a transaction flow according to an exemplary embodiment of the present disclosure.

FIG. 4 illustrates a method according to an exemplary embodiment of the present disclosure.

FIG. 5 illustrates a method according to an exemplary embodiment of the present disclosure.

FIG. 6 illustrates a flow diagram according to an exemplary embodiment of the present disclosure.

FIG. 7 illustrates a computer system according to an exemplary embodiment of the present disclosure.

### DETAILED DESCRIPTION OF EXAMPLE EMBODIMENTS

Third parties who are owed obligations may not be present for all transactions that trigger a financial obligation on their behalf. In such instances, one of the parties in the transaction may be responsible for providing a report of transactions and resulting obligation payments owed. However, third parties may have difficulty verifying the accuracy of such reports, as the third parties are not present for the underlying transactions, which can lead to payment evasion and foregone obligation payments. Furthermore, parties who owe financial obligations to third parties may often lack systems to automatically collect and process funds for obligation payments that are due. In particular, typical sales systems may collect information necessary to determine the total amount of obligation payments owed over a specified period, but the third parties are typically still responsible for ensuring that sufficient funds are reserved to cover these obligations. Therefore, there exists a need for an automated system that determines obligation payments owed to third parties and ensures that sufficient funds are reserved for fulfilment of the obligation payments owed. Examples of such situations may include sales or VAT or GST tax payments, royalty payments, usage fees on rented equipment, and/or various types of service or support fees.

One solution to this problem is to provide an automated system, into which a third party owed an obligation may have visibility, that automatically calculates and processes payments for transactions between parties. The system may be configured to maintain atomicity of the financial transactions by, e.g., processing obligation payments at the time that the transaction payment itself is processed. During the atomic processing of the transaction, obligation payments themselves may be processed using an obligations account that tracks a balance of obligations that a particular party to a transaction owes to the third party. As a result of the transaction, the balance of the obligations account may be updated. A hold on a financial account associated with the particular party may be updated based on the updated balance of the obligations account. The above process may all be completed as part of the atomic payment transaction, thereby insuring compliance to third party payment obligation. At regular intervals, funds may be transferred from the financial account to an obligation collections account associated with the third party, and the balance of the obligations account and hold on the financial account may be reset.

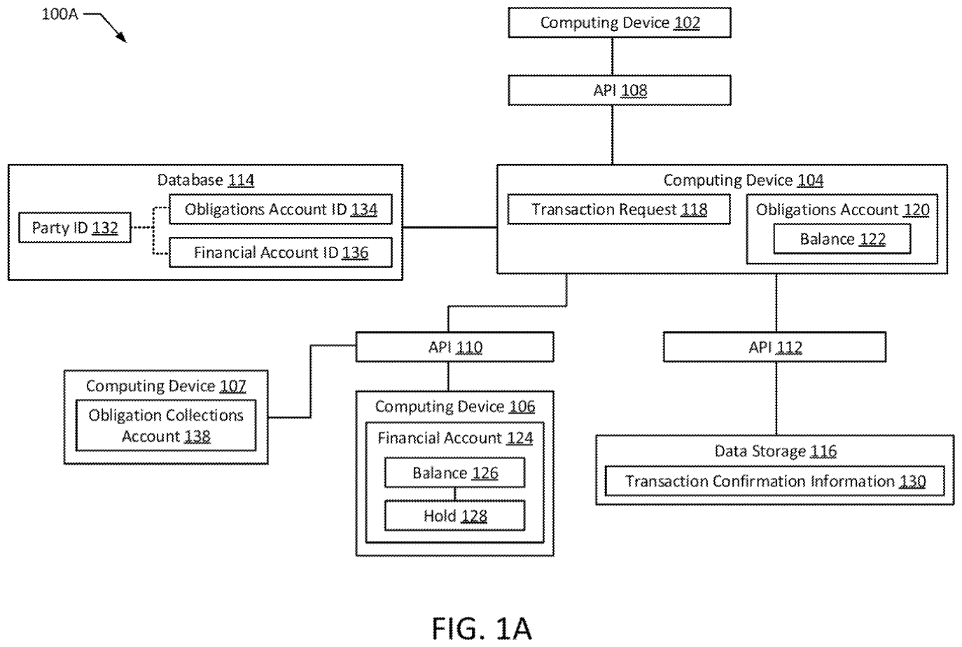

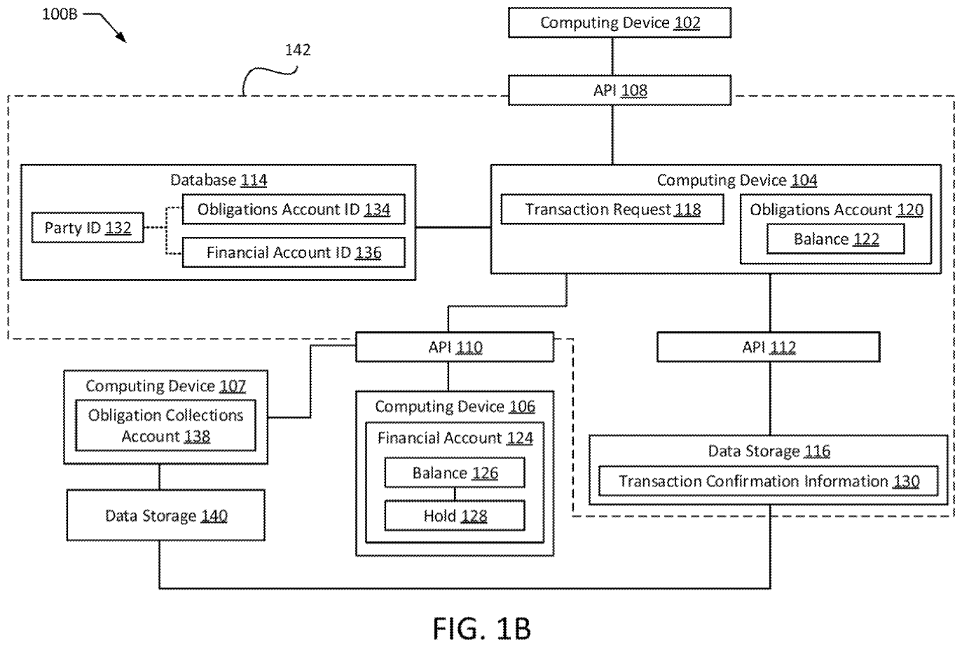

FIGS. 1A-1B illustrate systems 100A-B (collectively the system 100) according to an exemplary embodiment of the present disclosure. The system 100 may be configured to atomically process transaction requests such that payments are processed with corresponding obligation payments. In particular, the system 100 may be configured to process transmission requests for two-party transactions while also processing obligation payments owed to third parties as a result of the two-party transactions. The system 100 includes several computing devices 102, 104, 106, 107, a database 114, and a data storage 116.

The computing device 104 may be configured to receive transaction requests 118 from other computing devices 102. For example, the transaction requests 118 may be received from computing devices 102 associated with users seeking to complete a transaction. In certain implementations, the transactions may include, e.g., purchases on an online storefront, electronically processed payments for in-person purchases, credit card transactions at a point-of-sale device, payments to a contractor according to an agreement, income payments to an individual, and the like. These transactions may be staged or created, e.g., via payment platforms provided and/or displayed via an API 108 which may include both a payment platform API (e.g. Stripe API, Paypal API, or other payment platform API) and a point of sale API (e.g., a Shopify API, WooCommerce API, or other point of sale API). For example, the point of sale API may gather information about the transaction and third party payments due, and the payment platform API actually performs the payment based on the gather information. Such payments may trigger obligation payments to a third party, such as royalty payments, income garnishment, subcontractor payments, tax payments, and the like.

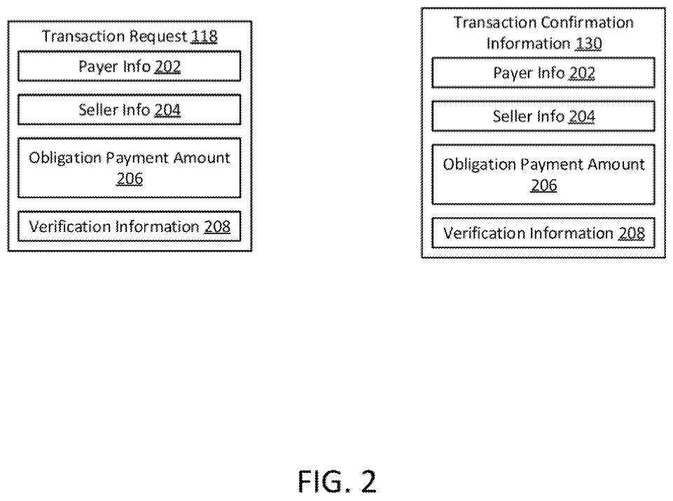

The transaction request 118 may contain information regarding the transaction to be completed and processed. For example, and referring to FIG. 2, the transaction requests 118 may include one or more of payer information 202, seller information 204, an obligation payment amount 206, and verification information 208. The payer information 202 may identify a paying party to the requested transaction. For example, the payer information 202 may include a numeric identifier (e.g., a tax ID, a business identification number, the unique numeric identifier) of a paying party, a name of a paying party, payment information for processing a payment from the paying party (e.g., a credit card, bank account, or other financial account used to fund the payment), or any other identifier of the paying entity in the transaction. The seller information 204 may identify a selling party to the requested transaction. For example, the seller information 204 may include a numeric identifier (e.g., a tax ID, a business identification number, the unique numeric identifier) of a selling party, a name of a selling party, payment information for receiving a payment from the paying party (e.g., a bank account or other financial account used to receive funds from the paying party), or any other identifier of the selling entity in the transaction. The obligation payment amount 206 may include a total amount to be paid to a third party (e.g., to be paid by the seller and/or to be paid by the buyer) as a result of the requested transaction. In certain implementations, in addition or alternative to the obligation payment amount 206, the transaction request 118 may include a total payment amount for the transaction request 118. For example, the total payment amount may reflect a total payment the payer will provide the seller under the requested transaction. The transaction request 118 may also include verification information 208. The verification information 208 may include information to verify that the contents of the transaction request 118 have not been altered after being generated by the computing device 102. For example, the verification information 208 may include one or more cryptographic checks (e.g., checksums, hashes, cryptographic signatures, and the like) that may be used to verify that all or part of the transaction request 118 has not been altered.

After receiving a transaction request 118, the computing device 104 may be configured to atomically process payment of the transaction and of one or more obligation payments owed as a result of the requested transaction. In particular, the computing device 104 may stage payment between two parties in the requested transaction. For example, based on information contained within the transaction request 118 (e.g., payer information, seller information), the computing device 104 may identify one or more financial accounts to be used in processing payments between the parties of the transaction. For example, and as explained further below, the financial accounts used to stage the payment may be identified based on information contained within the database 114. The staged payment may then be processed along with the obligation payment triggered by the transaction (e.g., after receiving final approval from a buyer or paying party).

The computing device 104 may also be configured to process an obligation payment owed as a result of the transaction. In particular, the computing device 104 may maintain an obligations account 120 on behalf of parties who owe obligation payments to third parties. In one example, the transaction request 118 may be to process a transaction between a buyer and a seller, where the seller owes an obligation payment to a third party (e.g., a tax authority, a royalty recipient, an income garnishment recipient) as a result of the transaction. In such instances, the computing device 104 and/or the system 100 may maintain an obligations account 120 for the obligations that the seller owes to the third party. The obligations account 120 may maintain a balance 122 reflecting the total amount owed to a particular third party. In particular, a positive balance 122 may indicate an amount of money owed to a particular third party as a result of transactions to which the seller was a party. In additional or alternative implementations, a negative balance 122 may indicate an amount of money owed to the particular third party. In practice, the computing device 104 and/or the system 100 may maintain multiple obligations accounts 120 for multiple parties. For example, a particular third party may be owed obligation payments from multiple transaction parties. The computing device 104 may maintain separate obligations accounts for each transaction party to separately track all balances owed to the third party. As another example, a particular transaction party may owe multiple obligation payments to multiple third parties. The computing device 104 may therefore maintain separate obligation payments for each third party to track balances owed by the particular transaction party.

Therefore, after receiving the transaction request 118, the computing device 104 may update the obligations account 120. In particular, the computing device 104 may update a balance 122 of the obligations account 120. For example, the computing device 104 may increase the balance 122 of the obligations account 120 based on an obligation payment amount 206 owed as a result of the transaction identified by the transaction request 118. In certain instances, the obligation payment amount 206 may be received as part of the transaction request 118. In additional or alternative implementations, the computing device 104 may calculate the obligation payment amount 206. For example, the transaction request 118 may identify a total purchase amount for the transaction request 118. The computing device 104 may determine the obligation payment amount 206 based on the total purchase amount. For example, the computing device 104 may use one or more pre-stored rules (e.g., indicating a percentage or gross total owed from each transaction) to calculate an obligation payment amount 206 based on the total purchase amount.

The obligations account 120 may be used to monitor an amount of money owed to a third party. However, in certain implementations, the obligations account 120 may not store or contain funds that can be used to make obligation payments. Instead, a financial account 124 associated with the transacting party may be used to fund and fulfil the obligation payments. In certain implementations, the financial account 124 may be a special-purpose account allocated with funds specifically to fulfil obligation payments. In additional or alternative implementations, the financial account 124 may be a regular account associated with the transacting party (e.g., the seller), such as a business checking account. The financial account 124 includes a balance 126, which may reflect a total amount of funds or money contained within the financial account 124. Additionally or alternatively, the balance 126 may reflect an available balance of the financial account 124.

To ensure that sufficient funds are available within the financial account 124 to meet the obligation payments owed by the transacting party (e.g., to fulfil the obligation payments reflected in the balance 122 of the obligations account 120), the financial account 124 may have a hold 128 placed at all or part of the funds within the balance 126. In particular, the hold 128 may be placed to restrict access to funds within the financial account 124 that are sufficient to cover the balance 122 of the obligations account 120. Accordingly, after updating the balance 122 in response to the received transaction request 118, the computing device 104 may update the hold 128 based on the balance 122. In additional or alternative implementations, the hold 128 may be updated on a regular basis (e.g., every night, every week) based on the balance 122. In particular, the hold 128 may be updated to account for the change in the balance 122 (e.g., to be equivalent or greater than the balance 122). In certain instances, holds 128 may be implemented as preauthorizations on the financial account 124. For example, the financial account 124 may represent a debit card or credit card and the hold 128 may be implemented as a preauthorization or preauthorized transaction hold on the financial account 124. In certain instances, updating the hold 128 to reduce the obligation owed may include issuing a refund or partial refund transaction (e.g., via the API 110) and/or making a normal payment or funds transfer to the financial account 124. In instances where there are insufficient funds in a financial account 124 to fulfil the hold 128, a warning message may be issued (e.g., to an entity or user associated with the financial account 124) and the hold 128 may be updated (or attempted to update) on a regular basis until successful.

The financial account 124, or access thereto, may be implemented by a computing device 106 different from the computing device 104. For example, the computing device 106 may be associated with a bank or another financial institution responsible for implementing and providing access to the financial account 124. In such instances, the hold 128 may be updated by the computing device 106 (e.g., based on a request received from the computing device 104).

As explained above, in practice, the computing device 104 may maintain or access multiple obligations accounts between multiple transacting parties and multiple third parties. Accordingly, in order to properly process received transactions requests 118, the computing device 104 may need to identify the correct obligations account 120 and the correct financial account 124. To do so, the computing device 104 may communicate with the database 114. The database 114 may store identifiers of parties and corresponding accounts. In particular, the database 114 may store party identifiers 132 along with associated obligation account identifiers 134 and/or financial account identifiers 136. The party identifiers 132 may include one or more of numeric identifiers of parties (e.g., buying parties, selling parties), names of parties, and the like. For example, the party identifiers 132 may include similar identifiers to those discussed above in connection with the payer info 202 and the seller info 204. The obligations account identifier 134 may include a numeric or textual identifier of the obligations account associated with the party ID 132. In additional or alternative implementations, the obligations account identifier 134 may include or otherwise be associated with an identifier of the third party to which obligation payments are tracked using the obligations account associated with the obligations account identifier 134 (e.g., for transacting parties with multiple obligations owed to multiple third parties). The financial account identifier 136 may include a numeric identifier of the account (e.g., a routing number for the account, an account number), an alphanumeric identifier of the account, and the like. Upon receiving a transaction request 118, the computing device 104 may request corresponding account identifiers for one or more parties to the transaction. For example, the computing device 104 may provide all or part of the seller information 204 to the database 114, which may be configured to return corresponding obligations account identifiers 134 and/or financial account identifiers 136.

After completing processing of the transaction, the computing device 104 may store a record of the completed transaction in a data storage 116. In particular, to ensure that the transaction is atomically processed, the transaction record associated with the transaction request 118 within the data storage 116 may be locked while processing the transaction. Once the transaction is complete, transaction confirmation information 130 may be provided to the data storage 116 for storage. In certain implementations, the record of the completed transaction may be created, updated, and stored according to a saga distributed transaction framework. In one alternative, the overall atomic transaction between two parties may be provided as a distributed transaction over microservices using, e.g., a Sage distributed transaction pattern. As depicted in FIG. 2, the transaction confirmation information 130 may include payer information 202, seller information 204, obligation payment amounts 206, and/or verification information 208, similar to the transaction request 118 discussed above. In certain implementations, the transaction confirmation information 130 may differ from the information contained within the transaction request 118. For example, in certain implementations, the transaction request 118 may contain a total purchase amount, but may not contain an obligation payment amount 206. In such instances, the transaction confirmation information 130 may contain the obligation payment amounts 206 (e.g., as calculated by the computing device 104). As another example, the verification information 208 included within the transaction confirmation information may differ at least in part from the verification information included in the transaction request 118. For example, the verification included within the transaction confirmation information 130 may include a confirmation number received from the financial account 124 (e.g., after updating the hold 128). In certain implementations, the data storage 116 may be implemented as one or more storage devices, such as databases data stores, data lakes, and the like. Additionally or alternatively, the data storage 116 may be implemented as a distributed ledger implemented by a plurality of nodes. For example, the data storage 116 may be implemented at least in part by a storage platform executing on top of a private blockchain, such as a Hyperledger blockchain, and/or a public blockchain, such as the Ethereum blockchain. In implementations where a public blockchain is used and/or where personal data is included within the transaction confirmation information 130, a cryptographic identifier may be stored on the blockchain instead of the personal data, and the cryptographic identifier may be used to retrieve the information (e.g., from another database). Such implementations may also be used to comply with General Data Protection Regulation requirements.

The above process may be repeated for multiple transactions received over the course of an obligation collections period. For example, funds may be transferred from the financial account 124 associated with the transacting party to an obligation collections account 138 associated with the third party owed payment under the obligation at regular intervals (e.g., every day, every week, every month, every quarter, every year). These regular intervals may define the obligation collections period. At the end of an obligation collections period, funds may be transferred to the obligation collections account 138. For example, the computing device 104 may transfer funds equivalent to the hold 128 from the financial account 124 to the obligation collections account 138 (e.g., in an Electronic Funds Transfer transaction). The computing device 104 may then update the obligations account 120 and the financial account 124 to indicate that the obligation payment has been transferred.

The obligation collections account 138, or access thereto, may be implemented by a computing device 107 different from the computing device 104. For example, the computing device 107 may be associated with a bank or another financial institution responsible for implementing and providing access to the obligation collections account 138. In practice, the obligation collections account 138 may be implemented as a financial account, similar to the financial account 124. Furthermore, as shown in FIG. 1B, the computing device 107 may also be communicatively coupled to a data storage 140. In practice, the data storage 140 may include a copy of transaction data stored within the data storage 116. The data storage 140 may allow a computing device associated with an obligation collections authority (e.g., a tax authority, a royalty payments authority) to view transaction confirmation information 130 to ensure that obligations account balances are correctly updated. In particular, as shown by the system boundary 142 in FIG. 1B, the computing device 104, the database 114, in the data storage 116 may be associated with a first entity (e.g., a payment processor). One or more of the APIs 108, 110, 112 may also be associated with the first entity. The computing devices 102, 106, 107 and the data storage 140 may be associated with different entities. For example, the computing device 102 may be associated with a customer and the computing device 106 may be associated with a bank. As another example, the computing device 107 in the data storage 140 may be associated with an obligation collections authority. Storing data separately and redundantly in the data storage 140 may enable the obligation collections authority to view the data without providing external access to the computing systems of the payment processor. In additional or alternative implementations, as discussed further herein, the data storage 116 may be implemented such that it is accessible by both the computing device 104 and a computing device associated with an obligation collections authority.

The computing devices 102, 104, 106, 107 may communicate using one or more application programming interfaces (APIs) 108, 110. The application programming interfaces may expose standardized functionality to exchange pre-defined data structures, such as transaction requests 118, financial account information, financial account holds, and financial account transactions. In certain implementations, the API 108 may be a transaction processing API (e.g., provided by a payment processing service, and obligation collection service, or the like. In certain implementations, the API 110 may be a financial transactions API (e.g., provided by financial account providers, banks, online payment providers, and the like). In certain instances, although not depicted, the computing device 104 may communicate with each of the computing devices 106, 107 using separate APIs instead of a single API 110. The computing device 104 may also communicate with the data storage 116 via an API 112. For example, where the data storage 116 is implemented as a distributed ledger, the API 112 may be provided to standardize communication between the computing device 104 and nodes implementing the distributed ledger. In certain implementations, the API 112 may be provided by a distributed ledger or blockchain transaction process. In additional or alternative implementations, the API 112 may be provided by a distributed ledger storage platform. Furthermore, although not depicted, an API may be used for communications between the computing device 104 and the database 114.

With reference again to FIG. 2, it should be understood that the depicted and discussed implementations of the transaction request 118 and the transaction confirmation information 130 are merely exemplary implementations. In light of the present disclosure, one skilled in the art may recognize additional or alternative information that may be included within further implementations of the transaction request 118 and/or the transaction confirmation information 130. All such implementations are considered within the scope of the present disclosure.

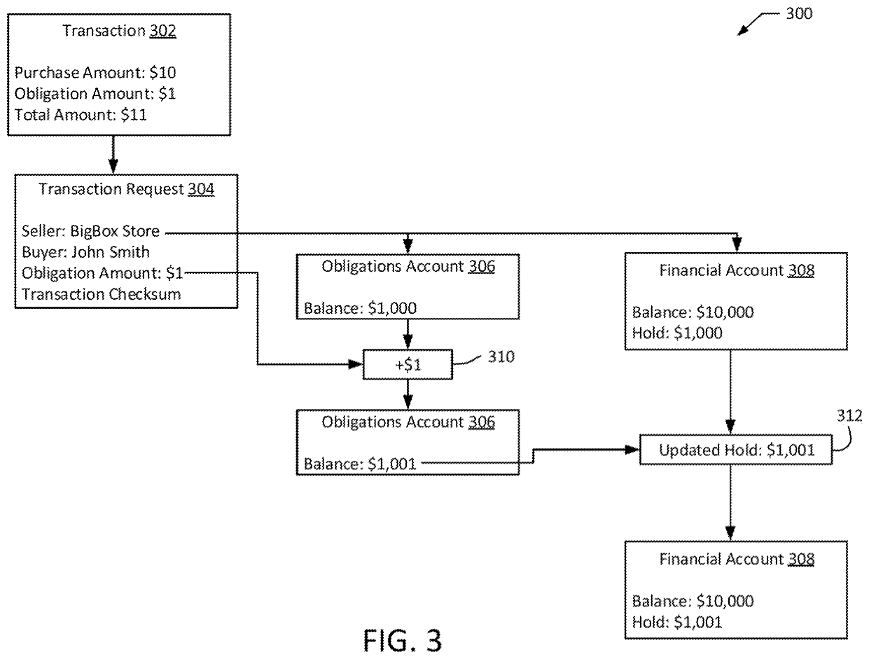

FIG. 3 illustrates a transaction flow 300 according to an exemplary embodiment of the present disclosure. The transaction flow 300 depicts how information for a transaction 302 is received and processed by the computing device 104. In particular, the transaction flow 300 may depict a flow for processing a transaction 302, which may be staged or created by a user of a computing device, such as the computing device 102. The transaction 302 includes a purchase amount of $10, an obligation amount of $1, and a total amount of $11. For example, a user of the computing device 102 may create the transaction 302 to make a purchase (e.g., from an online store, from a retail store). For example, the transaction 302 may be created by an application executing on the computing device 102, such as an application associated with a payments platform and/or associated with the store from which the user is making a purchase. As another example, the transaction 302 may be initiated at a point-of-sale device at a store with which a user is paying for the transaction.

Based on the transaction 302, a transaction request 304 may be generated. For example, the computing device 102 may generate the transaction request 304 for communication with the computing device 104. The transaction request 304 identifies the seller (i.e., “BigBox Store”), the buyer (i.e., “John Smith”), the obligation amount of $1, and a transaction checksum. Based on the seller information, such as the name of the BigBox Store or a numeric identifier of the BigBox Store, the computing device 104 may identify an obligations account 306 and a financial account 308. In particular, upon receiving the transaction request 304, the computing device 104 may determine that the seller owes an obligation payment to a third party as a result of the transaction. Accordingly, the computing device 104 may identify the obligations account 306 and the financial account 308 associated with the seller (e.g., based on information received from the database 114). The obligations account 306 associated with the seller has a balance before the transaction 302 of $1,000. The financial account 308 associated with the seller has a balance before the transaction 302 of $10,000 and a hold of $1,000, which may correspond to the balance of the obligations account 306.

Based on the obligation amount of $1 within the transaction request 304, the computing device 104 may determine a balance update 310 for the obligations account 306 of +$1, indicating that $1 should be added to the balance of the obligations account 306. As reflected below the balance update 310, the updated balance for the obligations account 306 is $1,001. Based on the updated balance, and updated hold 312 for the financial account 308 may be determined. The updated hold may be determined to be equal to the balance of the obligations account 306, and may accordingly be $1,001. As reflected below will be updated hold 312, the hold in the financial account 308 may be $1,001, matching the balance of the obligations account 306, once updated. This updated hold may ensure that sufficient funds are available to cover all obligation payments incurred by the seller as a result of transactions.

In practice, certain obligation payments may be transitive. For example, certain types of sales taxes (e.g., Australian GST/VAT) may be transitive such that a total sales tax owed by a first party as a seller can be reduced by other transactions in with the first party is a buyer. In one example, the first party (BigBox Store) associated with the obligations account 306 and the financial account 308 may, after completing the transaction, engage in another transaction where the first party purchases products (e.g., for inventory) from another party, such as a supplier. Specifically, the first party may purchase $1,000 of goods, incurring a $100 obligation payment (e.g., sales tax payment), for a total purchase price of $1,100. Based on the $100 obligation payment paid with this second transaction, the total obligation owed by the first party may be reduced by $100. Accordingly, a balance of the obligation account 306 may be reduced by $100 to $901 and the hold on the financial account 308 may be updated to $901 to accurately reflect the obligation owed by the first party. These updates may be processed atomically along with the payment, using techniques similar to those discussed above in connection with the transaction 302. Thus, in practice, processing a transaction may involve identifying multiple accounts associated with multiple parties of the transaction and updating corresponding obligations accounts and financial account holds based on the transaction.

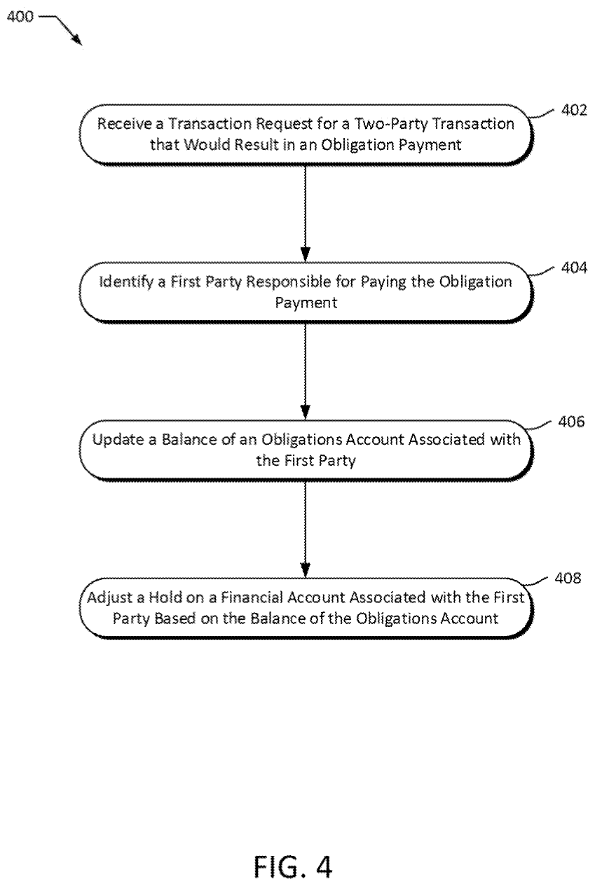

FIG. 4 illustrates a method 400 according to an exemplary embodiment of the present disclosure. The method 400 may be performed to atomically process payments and underlying obligation payments for two-party transactions. The method 400 may be implemented on a computer system, such as the system 100. For example, the method 400 may be implemented by one or more of the computing devices 102, 104, 106, 107. The method 400 may also be implemented by a set of instructions stored on a computer readable medium that, when executed by a processor, cause the computer system to perform the method 400. For example, all or part of the method 400 may be implemented by a processor and a memory of one or more of the computing devices 102, 104, 106, 107. Although the examples below are described with reference to the flowchart illustrated in FIG. 4, many other methods of performing the acts associated with FIG. 4 may be used. For example, the order of some of the blocks may be changed, certain blocks may be combined with other blocks, one or more of the blocks may be repeated, and some of the blocks described may be optional.

The method 400 may begin with receiving a transaction request (block 402). The transaction request 118 may be for a two-party transaction, which may result in an obligation payment to a third party for one of the parties to the transaction. For example, a computing device 104 may receive a transaction request 118 from another computing device 102, such as a computing device 102 associated with a party of the transaction (e.g., a buyer in a purchasing transaction). In response to receiving the transaction request 118, the computing device 104 may atomically process the transaction. In certain instances, rather than triggering a new obligation payment, a transaction may undo all or part of a previous obligation payment. For example, a reversal transaction may be submitted when a customer returns a product for a refund, resulting in a reduced obligation payment owed by a seller of the product.

While atomically processing the transaction, a first party responsible for paying the obligation payment may be identified (block 404). For example, the computing device 104 may identify the first party based on information included within the transaction request 118. In particular, the first party may be identified based on payer information 202 and/or the seller information 204 included within the transaction request. For example, the computing device 104 may be configured to identify the first party as a seller in the transaction. In another example, the computing device may be configured to identify the first party based on one or more pre-defined rules. In one specific example, the pre-defined rules may specify obligations between particular parties and corresponding third parties. The parties identified in the transaction request 118 may be compared to the pre-defined rules and the first party may be identified as a party with a corresponding obligation in the pre-defined rules.

A balance of an obligations account associated with the first party may be updated (block 406). For example, the computing device 104 may update a balance 122 of the obligations account 120. The obligations account 120 may be identified based on the first party. For example, the obligations account 120 may be identified based on an identifier received from a database 114. The balance 122 may be updated by adding an obligation payment amount 206 to the balance 122. Additionally or alternatively, where the transaction results in a reduced overall obligation payment (e.g., resulting from a returned product), the balance 122 may be updated by subtracting an obligation payment amount 206 from the balance 122. Furthermore, as explained above, in certain implementations a negative, rather than positive, balance 122 may indicate that an obligation balance is owed. In such instances, the above examples may be reversed. The obligation payment amount 206 to be added or subtracted from the balance 122 may be received in the transaction request 118 and/or may be calculated by the computing device 104, as explained above. In certain instances, updating the balance 122 may include adding the obligation payment amount 206 to a ledger or other record of obligation payments maintained by the obligations account 120.

A hold on a financial account associated with the first party may be updated based on the balance of the obligations account (block 408). For example, the computing device 104 may update a hold 128 on a financial account 124 associated with the first party who owes the obligation. The financial account 124 may be identified based on the first party. For example, the financial account 124 may be identified based on an identifier received from the database 114. The updated hold may be determined based on the balance 122 of the obligations account 120. To update the hold 128 on the funds in the financial account 124, the computing device may transmit a hold request with the updated hold amount (i.e., greater than or equal to the amount of the balance 122) to the computing device 106 via the API 110. In response, the computing device 106 may update the hold 128 on the financial account 124. As explained above, the hold 128 may be place as a preauthorization hold on a credit card or debit card account. In such instances, the corresponding financial institution providing the account may only reconcile transactions at regular intervals (e.g., hourly, daily, weekly). Accordingly, in such implementations, the hold 128 may be updated on the financial account 124 at a later time, after the transaction is complete. For example, the computing device 104 may update the hold 128 at the same regular interval, such as daily, to ensure that the hold 128 matches the balance 122 of the obligations account 120.

In the above-discussed examples, a single party is identified when processing a received transaction request. In practice, certain transaction requests (e.g., where two or more parties have associated tax identifiers) may include more than one party whose total obligation balance is affected. For example, as explained above, certain types of obligation payments may be transitive. In such instances, multiple parties may be identified at block 404 (e.g., a buyer and a seller). Furthermore, balances for obligations accounts associated with all identified parties may be updated at block 406 and holds associated with multiple financial accounts associated with all identified parties may be adjusted at block 408.

To ensure the atomicity of transactions and payments processed, final processing of the obligations account 120 and the hold 128 may be conditioned on approval of the transaction. In particular, all or part of blocks 404, 406, 408 may be performed in parallel with processing payments between the two parties of the transaction. As another example, all or part of blocks 404, 406, 408 be conditioned on approval of a processed payment between the two parties of the transaction. In response, blocks 404, 406, 408 may be performed. In such implementations, database entries corresponding to the transaction to be locked until the payment is processed and the hold on the financial account 124 is adjusted. In this manner, the obligations account 120 is kept up-to-date for all transactions processed on behalf of the first party. Furthermore, by updating the hold 128 in response to the updated balance 122 of the obligations account 120, the method 400 may ensure that an appropriate amount of funds in the financial hold 124 are reserved for payment of obligations owed by the first party.

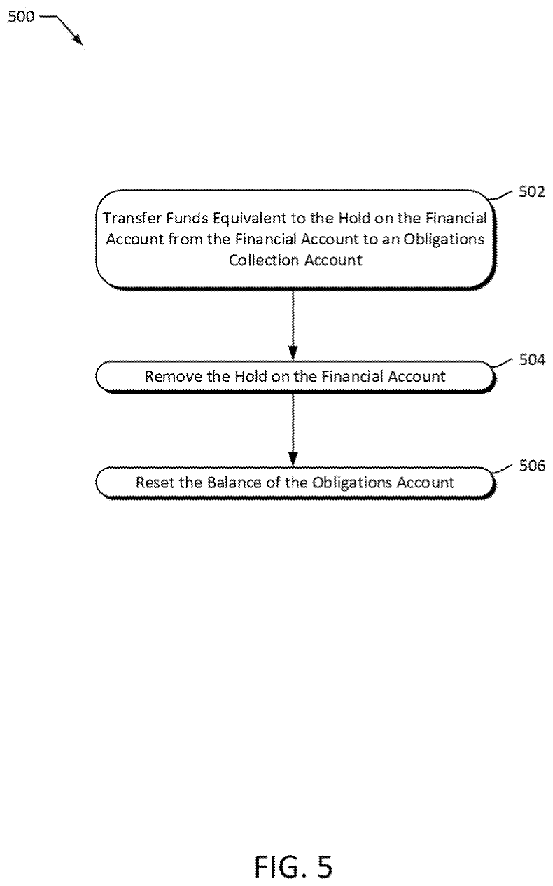

FIG. 5 illustrates a method 500 according to an exemplary embodiment of the present disclosure. The method 500 may be performed to transfer funds to an obligation collections account at the end of an obligation collections period. The method 500 may be implemented on a computer system, such as the system 100. For example, the method 500 may be implemented by one or more of the computing devices 102, 104, 106, 107. The method 500 may also be implemented by a set of instructions stored on a computer readable medium that, when executed by a processor, cause the computer system to perform the method 500. For example, all or part of the method 500 may be implemented by a processor and a memory of one or more of the computing devices 102, 104, 106, 107. Although the examples below are described with reference to the flowchart illustrated in FIG. 5, many other methods of performing the acts associated with FIG. 5 may be used. For example, the order of some of the blocks may be changed, certain blocks may be combined with other blocks, one or more of the blocks may be repeated, and some of the blocks described may be optional.

The method 500 may begin with transferring funds equivalent to the hold on a financial account from the financial account to an obligation collections account (block 502). For example, a computing device 104 may transmit a funds transfer request to financial account 124 associated with a first party to transfer funds to an obligation collections account 138. The obligation collections account 138 may be associated with a third party entitled to one or more obligation payments as a result of transactions including the first party. For example, the obligation collections account 138 may be associated with a tax authority entitled to sales tax on transactions including the first party. As another example, the obligation collections account 138 may be associated with a recipient of income garnishment payments from the first party. In response to determining that an obligation collections period has ended, the computing device 104 may determine an amount for the hold 128 and the financial account 124 (e.g., by querying the computing device 106 via the API 110). The computing device 104 may then request a transfer of funds equal to the hold 128 the obligation collections account 138. In response, the computing devices 106, 107 may communicate transfer the funds from the financial account 124 to the obligation collections account 138 (e.g., using an Electronic Funds Transfer).

The hold may then be removed from the financial account (block 504). For example, the computing device 104 remove the hold 128 from the financial account 124. In particular, after receiving confirmation that the transfer of block 502 has been completed, the computing device 104 may transmit, via the API 110, a hold request to the computing device 106 to remove or zero out the hold 128. In response, the computing device 106 may remove the hold 128 (or set the hold amount to $0).

A balance of an obligations account may be reset (block 506). For example, the computing device 104 may reset the balance 122 associated with the first party. In particular, because a new obligation collections period has begun and funds were successfully transferred to the obligation collections account 138, the first party may have a zero balance due for total obligation payments. Accordingly, the balance 122 may be reset to $0.

In this manner, the method 500 allows for the balances 122 and holds 128 created ultimate payments to the third party entitled to obligation payments. The method 500 may accordingly automate payment of obligation payments, improving trust and overall compliance with obligation payment requirements and reducing the transaction processing overhead necessary to track and transfer these payments. Also, by automating the collection of obligation payments, the method 500 helps business maintain less-encumbered cash flows which are net of particular obligations payments. In an alternative example 502 may come after 504 and before 506. It will also be appreciated that, in another alternative a CAPTURE API call may be used to capture automatically that the amount that is locked on a debit card with a PREAUTH operation. In this alternative, both 502 and 504 are completed during the single CAPTURE operation.

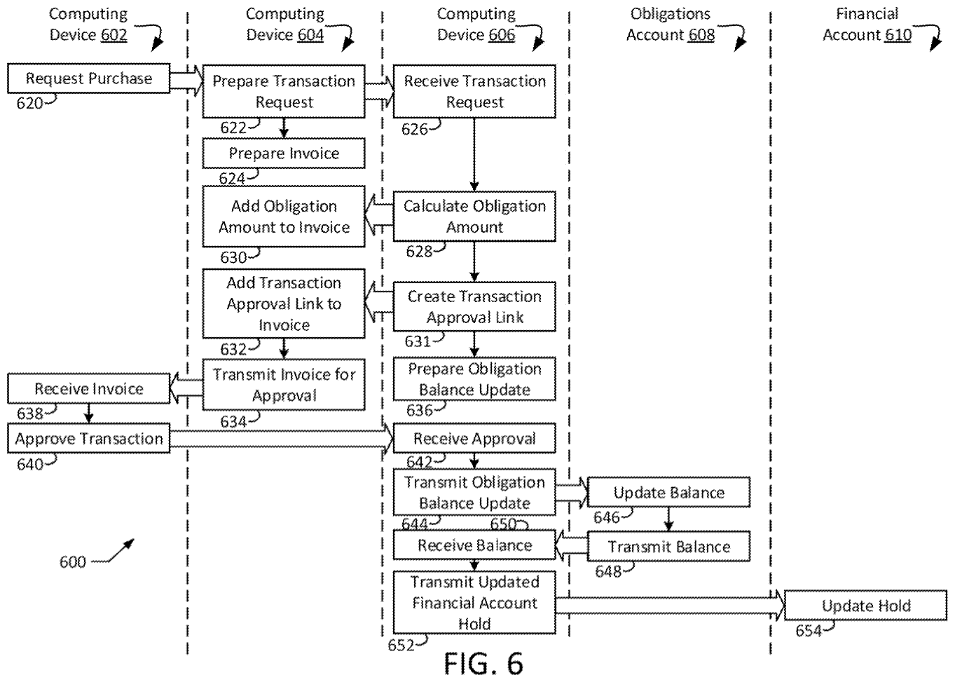

FIG. 6 illustrates a flow diagram 600 according to an exemplary embodiment of the present disclosure. Flow diagram 600 may be performed to completely process a transaction including processing of obligation payments owed due to the transaction. The flow diagram 600 includes a computing device 602, which may be associated with a purchaser or payer, a computing device 604, which may be associated with a seller or recipient, the computing device 606, which may be an exemplary implementation of the computing device 104, an obligations account 608, which may be an exemplary implementation of the obligations account 120, and a financial account 610, which may be an exemplary implementation of the financial account 124. Although the examples below are described with reference to the flowchart illustrated in FIG. 6, many other methods of performing the acts associated with FIG. 6 may be used. For example, the order of some of the blocks may be changed, certain blocks may be combined with other blocks, one or more of the blocks may be repeated, and some of the blocks described may be optional.

The flow diagram 600 may begin with the computing device 602 requesting a purchase (block 620). For example, a customer associated with the computing device 602 may create and request a purchase (e.g., from an online storefront). The requested purchase may be transmitted to the computing device 604 (e.g., via an API). In response, the computing device 604 may prepare a transaction request (block 622). The transaction request may be created to include information in a standardized format for a payment processing platform, such as a payment processing platform implemented by the computing device 106. The transaction request may then be transmitted to the computing device 606 for further processing (e.g., via an API). While the computing device 606 processes transaction request (as discussed below), the computing device 604 may prepare an invoice for the requested purchase (block 624). The invoice may include information regarding the requested transaction, such as goods or services purchased, a total purchase amount, buyer information, seller information, quantity information, and the like.

The computing device 606 may receive the transaction request (block 626). The computing device 606 may calculate an obligation amount for the transaction (block 628). For example, the computing device 606 calculates the obligation amount based on a total purchase amount indicated in the transaction request. As explained above, the obligation amount may be calculated using predefined rules, which may be associated with individual parties (such as the seller) and/or which may apply to all transactions that meet certain criteria (e.g., that occur within a particular location, that exceed a certain purchase price, where a sold product is shipped to a particular jurisdiction). The computing device 606 may transmit the obligation amount to the computing device 604, which may add the obligation amount to the invoice (block 630). For example, the computing device 604 may add the obligation amount to a corresponding field of the invoice. While processing the transaction request (e.g., while performing one or more of the blocks 626, 628, 631 (discussed below), the computing device 606 may place a hold on or otherwise lock access to a database record for the transaction. For example, the computing device 606 may create a transaction record associated with the transaction request within a database (e.g., data storage). The computing device 606 may lock access to the transaction record until atomic processing is complete, including subsequent steps reflected in the flow diagram 600. Additionally or alternatively, the transaction record (e.g., transaction confirmation information 130) may be not be created within a database but may instead be stored within the computing device 606 and may be locked from submission to a data storage until payment processing (and the flow chart 600) are complete). For example, a saga distributed transaction framework may be used create and store data records regarding transactions.

The computing device 606 may then create a transaction approval link (block 631). The transaction approval link may be used by the customer to provide final authorization to process the payment (and any underlying obligation payments). The transaction approval link may be created as, e.g., a URL to an approval website, a QR code containing an approval link, and authorization code, or any other mechanism for providing final authorization for payment. The transaction approval link may be transmitted to the computing device 604, which may add the approval link to the invoice (block 632) and may transmit the invoice to the computing device 602 for approval (block 634). Because the transaction is not finalized, the invoice may be considered a pro forma invoice.

The computing device 602 may then receive the invoice (block 638). The customer may then be able to review the invoice to ensure the purchase information is correct. The customer approves, the computing device 602 may approve the transaction (block 640). The approval may be transmitted to the computing device 606, which may receive the approval (block 642). While the customer receives and reviews the invoice (or prior to creating the transaction approval link), the computing device 606 may prepare an obligation balance update (block 636). For example, the computing device 606 may prepare an update to the balance of a corresponding obligations account 608 and/or may prepare updated holds on a financial account 610 based on transaction information (e.g., the obligation amount), using techniques similar to those discussed above. In certain implementations, the computing device 606 may also stage a payment between the two parties of the transaction requested by the computing device 602.

Upon receiving the approval at block 642, the computing device 606 may implement the prepared payments and updates. In particular, the computing device 606 may transmit an obligation balance updates to the obligations account 608 (block 644). The obligations account 608 update its balance (block 646) and may transmit the updated balance back to computing device 606 (block 648). The computing device 606 may receive the updated balance (box 650) and may transmit an updated financial account hold that the financial account 610 (block 652). The updated financial account hold may be prepared based on the updated balance of the obligations account 608. The financial account 610 may receive the updated financial account hold and may update a hold on funds within the financial account 610 based on the updated financial account hold (block 654). In certain instances, as explained above, updating the hold on the financial account 610 may be performed after completing processing (including payment processing) for the requested transaction. For example, the hold may be updated at regular intervals (e.g., daily) based on the balance of the obligations account 608. In such instances, one or more of blocks 648-654 may be performed after processing the transaction in order to update the hold.

In this manner, the obligations accounts and financial accounts may be kept up to date based on received transactions. Furthermore, by processing the obligations balance update and updated financial account hold along with the payment between the transaction parties after receiving approval, the computing device 606 can further ensure atomicity of the processed payment, improving trust in the obligation collection process and helping to automate payment processing. Furthermore, the computing device 606 is able to process obligation amount calculation and the transaction approval, reducing the processing required by sellers and other parties accepting payments.

In practice, application using the above-described systems and methods may be used for various types of applications and transactions. In a first example, the described techniques may be used to process tax payments, such as a sales tax or value added tax (e.g. a Goods and Services Tax). In particular, in response to a received transaction request for the sales of goods, it may be determined that completing the requested transaction would trigger a sales tax obligation to a tax authority, such as state tax authority in the United States and/or the Australian Tax Office. In response, the seller in the transaction may be identified based on a tax identification number (e.g., a State Tax Identification Number, an Australian Business Number) included within the transaction request. In particular, the transaction request may be received by a computing device associated with the tax authority. An obligation amount may then be calculated based on a sales rate and a total transaction amount identified within the transaction request. Once the transaction is approved, the tax authority may update a balance of and obligations account accessible by the tax authority based on the obligation amount incurred by the transaction. The tax authority may then also update a hold on a financial account associated with the seller. The financial account may be separately maintained by a bank associated with the seller, and the tax authority may not be able to directly access funds within the financial account and/or to view balances of the financial account.

In a second example, the described techniques may be used to process royalty payments. For example, sales of a copyrighted work (e.g., album sales, merchandise sales, art prints, book sales) may trigger royalty payments to a creator of the copyrighted work. In such instances, in response to receiving a transaction request, it may be determined that completing the requested transaction would trigger a royalty payment obligation to the creator of the copyrighted work (or other royalty recipient). In response, the seller and the creator may be identified based on the transaction request (e.g., indications of the goods serviced, identifiers of the seller). An obligation amount of may be determined based, e.g., on a royalty rate for the creator and a total purchase amount for the copyrighted work. In certain implementations, multiple creators may be owed differing royalty rates for the sale of a particular copyrighted work (e.g., depending on the underlying contribution to the copyrighted work). In such instances, the obligation amounts for each of the creators may be determined based on royalty rates associated with each creator, which may be stored in a database such as the database 114. In certain instances, the obligation amounts may not be provided to or included within an invoice presented to the customer. Once the transaction is approved, the obligations account balance and financial account hold may be updated as discussed above.

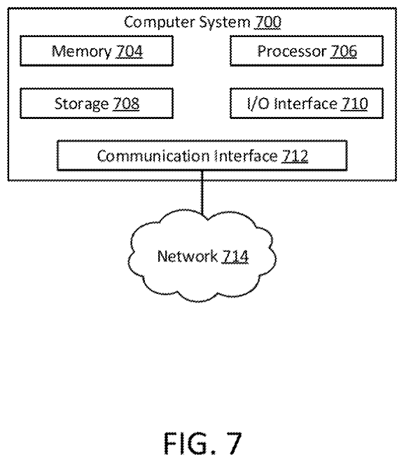

FIG. 7 illustrates an example computer system 700 that may be utilized to implement one or more of the devices and/or components discussed herein, such as the computing devices 102, 104, 106, 107, 602, 604, 606, the database 114, and/or the data storage 116. In particular embodiments, one or more computer systems 700 perform one or more steps of one or more methods described or illustrated herein, such as the method 200. In particular embodiments, one or more computer systems 700 provide the functionalities described or illustrated herein. In particular embodiments, software running on one or more computer systems 700 performs one or more steps of one or more methods described or illustrated herein or provides the functionalities described or illustrated herein. Particular embodiments include one or more portions of one or more computer systems 700. Herein, a reference to a computer system may encompass a computing device, and vice versa, where appropriate. Moreover, a reference to a computer system may encompass one or more computer systems, where appropriate.

This disclosure contemplates any suitable number of computer systems 700. This disclosure contemplates the computer system 700 taking any suitable physical form. As example and not by way of limitation, the computer system 700 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, the computer system 700 may include one or more computer systems 700; be unitary or distributed; span multiple locations; span multiple machines; span multiple data centers; or reside in a cloud, which may include one or more cloud components in one or more networks. Where appropriate, one or more computer systems 700 may perform without substantial spatial or temporal limitation one or more steps of one or more methods described or illustrated herein. As an example and not by way of limitation, one or more computer systems 700 may perform in real time or in batch mode one or more steps of one or more methods described or illustrated herein. One or more computer systems 700 may perform at different times or at different locations one or more steps of one or more methods described or illustrated herein, where appropriate.

In particular embodiments, computer system 700 includes a processor 706, memory 704, storage 708, an input/output (I/O) interface 710, and a communication interface 712. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 706 includes hardware for executing instructions, such as those making up a computer program. As an example and not by way of limitation, to execute instructions, the processor 706 may retrieve (or fetch) the instructions from an internal register, an internal cache, memory 704, or storage 708; decode and execute the instructions; and then write one or more results to an internal register, internal cache, memory 704, or storage 708. In particular embodiments, the processor 706 may include one or more internal caches for data, instructions, or addresses. This disclosure contemplates the processor 706 including any suitable number of any suitable internal caches, where appropriate. As an example and not by way of limitation, the processor 706 may include one or more instruction caches, one or more data caches, and one or more translation lookaside buffers (TLBs). Instructions in the instruction caches may be copies of instructions in memory 704 or storage 708, and the instruction caches may speed up retrieval of those instructions by the processor 706. Data in the data caches may be copies of data in memory 704 or storage 708 that are to be operated on by computer instructions; the results of previous instructions executed by the processor 706 that are accessible to subsequent instructions or for writing to memory 704 or storage 708; or any other suitable data. The data caches may speed up read or write operations by the processor 706. The TLBs may speed up virtual-address translation for the processor 706. In particular embodiments, processor 706 may include one or more internal registers for data, instructions, or addresses. This disclosure contemplates the processor 706 including any suitable number of any suitable internal registers, where appropriate. Where appropriate, the processor 706 may include one or more arithmetic logic units (ALUs), be a multi-core processor, or include one or more processors 706. Although this disclosure describes and illustrates a particular processor, this disclosure contemplates any suitable processor.

In particular embodiments, the memory 704 includes main memory for storing instructions for the processor 706 to execute or data for processor 706 to operate on. As an example, and not by way of limitation, computer system 700 may load instructions from storage 708 or another source (such as another computer system 700) to the memory 704. The processor 706 may then load the instructions from the memory 704 to an internal register or internal cache. To execute the instructions, the processor 706 may retrieve the instructions from the internal register or internal cache and decode them. During or after execution of the instructions, the processor 706 may write one or more results (which may be intermediate or final results) to the internal register or internal cache. The processor 706 may then write one or more of those results to the memory 704. In particular embodiments, the processor 706 executes only instructions in one or more internal registers or internal caches or in memory 704 (as opposed to storage 708 or elsewhere) and operates only on data in one or more internal registers or internal caches or in memory 704 (as opposed to storage 708 or elsewhere). One or more memory buses (which may each include an address bus and a data bus) may couple the processor 706 to the memory 704. The bus may include one or more memory buses, as described in further detail below. In particular embodiments, one or more memory management units (MMUs) reside between the processor 706 and memory 704 and facilitate accesses to the memory 704 requested by the processor 706. In particular embodiments, the memory 704 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 704 may include one or more memories 704, where appropriate. Although this disclosure describes and illustrates particular memory implementations, this disclosure contemplates any suitable memory implementation.

In particular embodiments, the storage 708 includes mass storage for data or instructions. As an example and not by way of limitation, the storage 708 may include a hard disk drive (HDD), a floppy disk drive, flash memory, an optical disc, a magneto-optical disc, magnetic tape, or a Universal Serial Bus (USB) drive or a combination of two or more of these. The storage 708 may include removable or non-removable (or fixed) media, where appropriate. The storage 708 may be internal or external to computer system 700, where appropriate. In particular embodiments, the storage 708 is non-volatile, solid-state memory. In particular embodiments, the storage 708 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 708 taking any suitable physical form. The storage 708 may include one or more storage control units facilitating communication between processor 706 and storage 708, where appropriate. Where appropriate, the storage 708 may include one or more storages 708. Although this disclosure describes and illustrates particular storage, this disclosure contemplates any suitable storage.

In particular embodiments, the I/O Interface 710 includes hardware, software, or both, providing one or more interfaces for communication between computer system 700 and one or more I/O devices. The computer system 700 may include one or more of these I/O devices, where appropriate. One or more of these I/O devices may enable communication between a person (i.e., a user) and computer system 700. As an example and not by way of limitation, an I/O device may include a keyboard, keypad, microphone, monitor, screen, display panel, mouse, printer, scanner, speaker, still camera, stylus, tablet, touch screen, trackball, video camera, another suitable I/O device or a combination of two or more of these. An I/O device may include one or more sensors. Where appropriate, the I/O Interface 710 may include one or more device or software drivers enabling processor 706 to drive one or more of these I/O devices. The I/O interface 710 may include one or more I/O interfaces 710, where appropriate. Although this disclosure describes and illustrates a particular I/O interface, this disclosure contemplates any suitable I/O interface or combination of I/O interfaces.

In particular embodiments, communication interface 712 includes hardware, software, or both providing one or more interfaces for communication (such as, for example, packet-based communication) between computer system 700 and one or more other computer systems 700 or one or more networks 714. As an example and not by way of limitation, communication interface 712 may include a network interface controller (NIC) or network adapter for communicating with an Ethernet or any other wire-based network or a wireless NIC (WNIC) or wireless adapter for communicating with a wireless network, such as a Wi-Fi network. This disclosure contemplates any suitable network 714 and any suitable communication interface 712 for the network 714. As an example and not by way of limitation, the network 714 may include one or more of an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 700 may communicate with a wireless PAN (WPAN) (such as, for example, a Bluetooth® WPAN), a WI-FI network, a WI-MAX network, a cellular telephone network (such as, for example, a Global System for Mobile Communications (GSM) network), or any other suitable wireless network or a combination of two or more of these. Computer system 700 may include any suitable communication interface 712 for any of these networks, where appropriate. Communication interface 712 may include one or more communication interfaces 712, where appropriate. Although this disclosure describes and illustrates a particular communication interface implementations, this disclosure contemplates any suitable communication interface implementation.

The computer system 702 may also include a bus. The bus may include hardware, software, or both and may communicatively couple the components of the computer system 700 to each other. As an example and not by way of limitation, the bus may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these buses. The bus may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

Herein, the terms “comprise”, “comprises”, “comprised” or “comprising”, “including” or “having” and the like in the present specification and claims are used in an inclusive sense, that is to specify the presence of the stated features but not preclude the presence of additional or further features.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

All of the disclosed methods and procedures described in this disclosure can be implemented using one or more computer programs or components. These components may be provided as a series of computer instructions on any conventional computer readable medium or machine readable medium, including volatile and non-volatile memory, such as RAM, ROM, flash memory, magnetic or optical disks, optical memory, or other storage media. The instructions may be provided as software or firmware, and may be implemented in whole or in part in hardware components such as ASICs, FPGAs, DSPs, or any other similar devices. The instructions may be configured to be executed by one or more processors, which when executing the series of computer instructions, performs or facilitates the performance of all or part of the disclosed methods and procedures.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

1. A system comprising:
a first computing device, a second computing device, and a third computing device,
wherein the first computing device is configured to:
receive first transaction information from a customer for a first two-party transaction; and
transmit a first transaction request including at least a subset of the transaction information to the second computing device;
wherein the second computing device is configured to atomically complete the first two-party transaction and, as part of completing the first two-party transaction:
determine a first obligation payment to a third party associated with the first two-party transaction;
identify, using first data from the first transaction request to query a first database, a first party responsible for paying the first obligation payment;
responsive to identifying the first party responsible for paying the obligation payment, increase a balance of an obligations account associated with the first party to incorporate the first obligation payment; and
increase, via the third computing device, a hold on a financial account associated with the first party based on the balance of the obligations account;
wherein the second computing device is further configured to receive a second transaction request related to a second two-party transaction; and
atomically complete the second two-party transaction and, as part of completing the second two-party transaction:
determine a second obligation payment to the third party associated with the second two-party transaction;
identify, using second data from the second transaction request to query the first database, a second party responsible for paying the second obligation payment;
decrease the balance of the obligations account associated with the first party based on the second obligation payment; and
decrease the hold on the financial account associated with the first party based on the balance of the obligations account.

2. The system of claim 1, wherein, while atomically completing the first two-party transaction, the second computing device is configured to process a payment to the first party.

3. The system of claim 1, wherein, while atomically completing the first two-party transaction, the second computing device is configured to lock a transaction record associated with the first two-party transaction until at least the hold on the financial account is successfully adjusted.

4. The system of claim 1, wherein the first computing device receives the transaction information from a payment API accessed by a payer of the first two-party transaction, and wherein the payer is presented, before the balance of the obligations account is increased, with an invoice that includes an obligation payment amount for the obligation payment.

5. The system of claim 1, wherein increasing the balance of the obligations account indicates that the first party owes a larger obligation to the third party and decreasing the balance of the obligations account indicates that the first party owes a smaller obligation to the third party.

6. The system of claim 1, wherein the second computing device is further configured, at an end of an obligation collections period, to:
transfer, via the third computing device, funds equivalent to the hold on the financial account from the financial account to an obligation collections account;
remove, via the third computing device, the hold; and
reset out the balance of the obligations account associated with the first party.

7. The system of claim 1, wherein the first transaction information includes information selected from the group consisting of: payer information, seller information, an obligation payment amount, and transaction verification information.

8. The system of claim 7, wherein the second computing device is further configured to store the first transaction information on a distributed ledger.

9. A method comprising:
receiving a first transaction request for a first two-party transaction that would result in a first obligation payment to a third party;
atomically completing the first two-party transaction; and
as part of atomically completing the first two-party transaction:
identifying, using first data from the first transaction request to query a first database, a first party responsible for paying the first obligation payment;
responsive to identifying the first party responsible for paying the first obligation payment, increasing a balance of an obligations account associated with the first party to incorporate the first obligation payment; and
increasing a hold on a financial account associated with the first party based on the balance of the obligations account; and
receiving a second transaction request related to a second two-party transaction;
atomically completing the second two-party transaction; and
as part of atomically completing the second two-party transaction:
determining a second obligation payment to the third party associated with the second two-party transaction;
identifying, using second data from the second transaction request to query the first database, a second party responsible for paying the second obligation payment;
decreasing the balance of the obligations account associated with the first party based on the second obligation payment; and
decreasing the hold on the financial account associated with the first party based on the balance of the obligations account.

10. The method of claim 9, wherein atomically completing the first two-party transaction further comprises processing a payment to the first party.

11. The method of claim 9, wherein atomically completing the first two-party transaction further comprises locking a transaction record associated with the first two-party transaction until at least the hold on the financial account is successfully adjusted.

12. The method of claim 9, wherein the first transaction request is received from an application programming interface (API) accessed by a payer of the first two-party transaction, and wherein the payer is presented, before the balance of the obligations account is increased, with an invoice that includes an obligation payment amount for the first obligation payment.

13. The method of claim 9, wherein increasing the balance of the obligations account indicates that the first party owes a larger obligation to the third party and decreasing the balance of the obligations account indicates that the first party owes a smaller obligation to the third party.

14. The method of claim 9, further comprising calculating an obligation payment amount for the first obligation payment based on at least one pre-defined rule and a total purchase amount of the first two-party transaction.

15. The method of claim 9, further comprising, at an end of an obligation collections period:
transferring funds equivalent to the hold on the financial account from the financial account to an obligation collections account;
removing the hold; and
resetting out the balance of the obligations account associated with the first party.

16. The method of claim 9, wherein the first two-party transaction includes transaction information selected from the group consisting of: payer information, seller information, buyer information, an obligation payment amount, and transaction verification information.

17. The method of claim 16, further comprising storing the transaction information on a distributed ledger.

18. The method of claim 16, wherein the first party, the obligations account, and the financial account are identified based on at least one of the seller information and/or the buyer information.

19. The method of claim 9, wherein the first obligation payment includes at least one of a royalty payment, an income garnishment, a contract payment, and a tax payment.

20. A non-transitory, computer-readable medium storing instructions which, when executed by a processor, cause the processor to:
receive a first transaction request for a first two-party transaction that would result in a first obligation payment to a third party;
atomically complete the first two-party transaction; and
as part of atomically completing the first two-party transaction:
identifying, using first data from the first transaction request to query a first database, a first party responsible for paying the first obligation payment;
responsive to identifying the first party responsible for paying the first obligation payment, increase a balance of an obligations account associated with the first party to incorporate the first obligation payment; and
increase a hold on a financial account associated with the first party based on the balance of the obligations account;
receive a second transaction request related to a second two-party transaction;
atomically complete the second two-party transaction; and
as part of atomically completing the second two-party transaction:
determine a second obligation payment to the third party associated with the second two-party transaction;
identify, using second data from the second transaction request to query the first database, a second party responsible for paying the second obligation payment;
decrease the balance of the obligations account associated with the first party based on the second obligation payment; and
decrease the hold on the financial account associated with the first party based on the balance of the obligations account.
